(19) United States
(12) Patent Application Publication
(10) Pub. No.: US 2026/0335899 A1
(43) Pub. Date: Oct. 29, 2026

(54) SAMPLE TUBE HOLDER, MOUNTING AID DEVICE, AND SAMPLE TUBE TRANSPORT SYSTEM

(71) Applicants: Roche Diagnostics GmbH, Mannheim (DE); Roche Diagnostics International AG, Rotkreuz (CH)

(72) Inventors: Kunal Chaudhary, Ludwigsburg (DE); Claudio Cherubini, Cham (CH); Lech Margner, Leonberg (DE); Daniel Mueller, Meierskappel (CH); Nikhil Muthyala, Stuttgart (DE); Jan Pauls, Berlin (DE); Gernot Schwab, Stuttgart (DE); Heiko Wagner, Fellbach (DE)

(21) Appl. No.: 19/702,637

(22) Filed: Jun. 9, 2026

Related U.S. Application Data
(63) Continuation of application No. PCT/EP2024/087179, filed on Dec. 18, 2024.

(30) Foreign Application Priority Data
Dec. 20, 2023 (EP) 23218557.9

(51) Int. Cl. B01L 9/06; G01N 35/04

(52) U.S. Cl. CPC B01L 9/06; G01N 35/04; B01L 2200/028; B01L 2300/123; G01N 2035/0406; G01N 2035/0496

(57) ABSTRACT

The invention relates to a sample tube holder (1) for a laboratory sample tube transport system (100), comprising: a radial inner support member (2) having a central opening (3), a radial outer support member (4) coaxially nesting the radial inner support member (2), a spring element (5), the spring element (5) comprising: a base portion (6) extending along a circumferential direction (C) and being coaxially nested in between the radial inner support member (2) and the radial outer support member (4), and finger portions (7) integrally protruding from the base portion (6) and being curved radially inwardly, the finger portions (7) being adapted to be elastically deflected radially outwardly by a sample tube (T) axially penetrating the central opening (3); and clamping pairs (8) distributed along the circumferential direction (C), the clamping pairs (8) respectively comprising a first clamping portion (9) for clamp-abutting the base portion (6) and a second clamping portion (10) for clamp-abutting the base portion (6) directly opposite said first clamping portion (9), the radial inner support member (2) comprising the first clamping portions (9) and the radial outer support member (4) comprising the second clamping portions (10).

The invention relates to a sample tube holder for a laboratory sample tube transport system, to a mounting aid device for mounting of such a sample tube holder within such a laboratory sample transport system, and to such a laboratory sample tube transport system.

Typically, laboratory sample tube transport systems for transporting sample tubes comprise a number of sample tube holders. The sample tube holders are usually adapted to accept a respective sample tube, so that the accepted sample tube can be transported within the laboratory sample tube transport system by moving the sample tube holder, for instance by means of a conveyor device of the laboratory sample tube transport system. Therein, such a sample tube holder conventionally comprises an elastic means that is elastically deformed by the sample tube accepted by the sample tube holder and therewith tensioned, so that a, in particular frictional, holding force acting on the sample tube is generated from the tensioning of the elastic means.

EP 3 211 426 A1 discloses a sample container carrier having an outer sleeve, an inner sleeve, and a retaining structure, the retaining structure being fixed in position along a direction of a central axis of the sample container carrier.

It is an object of the present invention to provide for a sample tube holder for a laboratory sample tube transport system, for a mounting aid device for mounting of such a sample tube holder at a conveyor device of a laboratory sample transport system, and for a laboratory sample transport system, each having improved properties. In particular, a fatigue strength of the sample tube holder, in particular of a spring element of the sample tube holder, is to be improved.

A sample tube holder according to the invention is adapted for use in a laboratory sample tube transport system. The laboratory sample tube transport system may be adapted for use in a laboratory automation system. The laboratory automation system may comprise a number of pre-analytical, analytical and/or post-analytical stations, in which samples, for example blood, saliva, swab and other specimens taken from the human body and/or cultures are processed. Sample tubes are sample containers for containing the samples. The sample tubes may be referred to as test tubes.

The sample tube holder comprises a radial inner support member having a central opening for axially accepting a respective sample tube. The radial inner support member may have a substantially annular shape. “Axially” may refer to an axial direction of the sample tube holder.

The sample tube holder comprises a radial outer support member coaxially nesting the radial inner support member. The radial inner support member may be coaxially nested by the radial outer support member, in particular with respect to the axial direction. The radial outer support member and the radial inner support member may overlap one another along the axial direction, in particular at least partially.

The sample tube holder comprises a spring element. The spring element has a base portion which extends along a circumferential direction of the sample tube holder at least partially or only partially. The base portion may have a substantially annular shape. If the base portion extends only partially along the circumferential direction, the base portion may have an interrupted ring-shape. In afore-said case, the spring element may be bent to its interrupted ring-shape from a substantially flat sheet metal cut-out, in particular in an especially cost-advantageously manner. The base portion of the spring element is coaxially nested in between the radial inner support member and the radial outer support member. The radial inner support member, the base portion and the radial outer support member may be arranged in an onion skin-like manner.

“Radial” may refer to a radial direction of the sample tube holder. The radial direction may be perpendicular to both the axial direction and the circumferential direction. The circumferential direction may extend around the axial direction, in particular within a radial plane that runs perpendicular to the axial direction.

The spring element has a number of finger portions. The finger portions protrude from the base portion integrally. In particular, the radial inner support member and/or by the radial outer support member do not axially overlap the finger portions. The finger portions are curved radially inwardly. In particular, the finger portions are inscribed a, in particular virtual, bell-shaped envelope. The base portion may form a rim of the bell-shaped envelope. The finger portions are adapted to be elastically deflected radially outwardly by a sample tube axially penetrating the central opening of the radial inner support member. In particular, the finger portions are adapted to self-center the sample tube axially penetrating the central opening.

The sample tube holder comprises a number of clamping pairs which are adapted to clamp the base portion in between the radial inner support member and the radial outer support member. The number of clamping pairs may correspond to the number of finger portions. The clamping pairs are distributed along the circumferential direction, in particular at a distance relative to one another. Therein, the clamping pairs respectively comprise a first clamping portion for clamp-abutting the base portion and a second clamping portion for clamp-abutting the base portion directly opposite said first clamping portion. Thus, the base portion is clamped in between the first clamping portions and the second clamping portions. Therein, the first clamping portions are comprised by the radial inner support member and the second clamping portions are comprised by the radial outer support member. Thus, the base portion may be clamped in between the radial inner support member and the radial outer support member at the clamping pairs.

Advantageously, not only the finger portions of the spring element may thus provide for elastic flex when accepting the sample tube, but also areas of the base portion which are not clamp-abutted by the clamping pairs. In particular, other areas of the spring element that are clamp-abutted do not experience deformation when the sample tube penetrates the central opening. This may result in a particular great amount of the spring element to be used for elastic deformation of the spring element when the sample tube axially penetrates the central opening. This may allow for particularly low stresses within the spring element, in particular including particularly few and/or low stress peaks. Thus, the sample tube holder, in particular its spring element, may have a particularly well fatigue strength.

According to an embodiment of the invention, the radial inner support member comprises radial protrusions distributed along the circumferential direction. Therein, the radial protrusions of the radial inner support member respectively comprise one of the first clamping portions. In particular, the radial protrusions of the radial inner support member protrude radially outwardly. In addition, or as an alternative, the radial outer support member comprises radial protrusions distributed along the circumferential direction, the radial protrusions of the radial outer support member respectively comprising one of the second clamping portions. In particular, the radial protrusions of the radial outer support member protrude radially inwardly.

According to another embodiment of the invention, the radial inner support member comprises radial recesses. Therein, the radial recesses of the radial inner support member and the first clamping portions are alternatingly arranged along the circumferential direction. In particular, the radial recesses of the radial inner support member are recessed radially inwardly. In addition, or as an alternative, the radial outer support member comprises radial recesses, the radial recesses of the radial outer support member and the second clamping portions being alternatingly arranged along the circumferential direction. In particular, the radial recesses of the radial outer support member being recessed radially outwardly.

It can be sufficient, if either the radial inner support member or the radial outer support member has radial protrusions and/or radial recesses. In this case the respective counterpart may have a steady, in particular circumferential, surface, said surface comprising the clamping portions of said counterpart, in particular without the clamping portions of said counterpart being offset relative to said surface.

In particular, at least one of the radial recesses may have a, in particular substantially, planar surface portion, said planar surface portion being perpendicular to a radial direction of the sample tube holder and/or tangentially to the circumferential direction.

According to another embodiment of the invention, the base portion is only locally clamped in between the radial inner support member and the radial outer support member at the clamping pairs, in particular radially.

According to another embodiment of the invention, the base portion is clamped radially between the radial inner support member and the radial outer support member at the clamping pairs, so that axially the spring element is, in particular only and/or substantially, frictionally connected to the radial inner support member and the radial outer support member. The term “frictionally connected” may therein be understood in the sense of “connected by friction” and/or “frictionally mounted” and/or “mounted by friction” and/or “frictionally borne” and/or “borne by friction”. In particular “frictionally connected” may be understood to be in contrast to a—more particular bi-or multidirectional—form-fit connection. In particular an axial gap defining an axial play of the spring element relative to the radial inner support member and relative to the radial outer support member is present in between the base portion and the radial inner support member and/or in between the base portion and the radial outer support member. In particular, due to the axial frictional connection, the spring element is not rigidly fixed to both the support members, axially. Thus, the axial frictional connection may allow for an, in particular limited, axial movement of the spring element relative to both the support members against clamping friction within the axial play defined by the gap. The frictional connection may enable a particular long lifetime of the sample tube holder, in particular of the spring element.

According to another embodiment of the invention, the base portion comprises a number of torsion portions distributed along the circumferential direction. In particular, the torsion portions may be distributed along the circumferential direction with a distance in between one another. Therein, at the torsion portions, the base portion is not clamped in between the radial inner support member and the radial outer support member, in particular radially. In particular, at least one of the finger portions protrudes from a respective one of the torsion portions. In particular, each of the finger portions protrudes from a respective one of the torsion portions. If a respective finger portion is deflected radially outwardly, the finger portion itself may bend and the torsion portion from which said finger portion protrudes may twist, in particular around the circumferential direction.

The base portion of the spring element may have flat portions, said flat portions extending substantially planarly perpendicular to the radial direction and/or tangentially to the circumferential direction. The finger portion may integrally protrude from one of the flat portions, respectively. The flat portions may be comprised by the torsion portions, respectively.

According to another embodiment of the invention, the spring element comprises a number of radial projections integrally protruding from the base portion, in particular from torsion portions of the base portion. In particular, each of the radial projections integrally protrudes from a respective one of the torsion portions. Therein, the radial inner support member and/or the radial outer support member have a flange portion for mutual axial abutment of the radial inner support member and the radial outer support member. The radial inner support member and/or the radial outer support member have recessed pockets partially delimited by the flange portion, in particular axially. The radial projections of the spring element being axially and/or radially movable accepted by the recessed pockets, respectively. The recessed pockets may limit a movability of the radial projections relative to the flange portion. The radial projections may be offset from the finger portions along the circumferential direction, respectively.

According to another embodiment of the invention, the radial inner support member and the radial outer support member and the spring element are comprised by a spring module of the sample tube holder. The spring module can be pre-assembled.

According to another embodiment of the invention, the sample tube holder comprises a housing for carrying the spring module. Therein, the housing has an inner circumferential contour for form-fittingly accepting the radial inner support member and/or the radial outer support member of the spring module.

In particular, the sample tube holder comprises a, in particular ring-shaped, gliding member carried by the housing. In particular, the gliding member is arranged coaxially with respect to the spring module. In particular the gliding member comprises one of the outermost axial endings of the sample tube holder.

According to another embodiment of the invention, the housing comprises two housing parts which are attached to one another perpendicular to the axial direction of the sample tube holder. Therein, the housing parts respectively have a semi-circumferential contour segment of the inner circumferential contour. The inner circumferential contour is completed by, in particular permanently, attaching the housing parts to one another. The housing parts may be permanently attachable to one another by integral rivets.

The housing, in particular at least one of both of the housing parts, may be made from a polymer material, in particular by injection molding.

According to another embodiment of the invention, the sample tube holder has at least two, in particular exactly two, spring modules. Therein, the spring modules are coaxially arranged at an axial distance relative to one another. In particular, the spring modules are pre-assembled at least partially from substantially similar or equal components. In particular, the spring modules have at least equally configured spring elements.

According to another embodiment of the invention, the axial distance in between the at least two spring modules is less than a respective axial extension of, in particular each of, the spring modules, so that the spring modules partially axially overlap. In addition, or as an alternative, the spring modules are angularly shifted relative to one another around the circumferential direction, in particular by 25 ° to 35 °.

The radial inner support member of one of the spring modules may have radial notches which are adapted and arranged to radially accept the finger portions of another spring module if said finger portions are elastically deflected radially outwardly. Thus, the finger portions of the other spring module may possibly be elastically deflected radially outwardly beyond an inner diameter of the central opening of the radial inner support member having the radial notches. This can allow for a particularly small axial distance between the spring modules, in particular without losing radial deflection capacity.

According to another embodiment of the invention, the sample tube holder comprises at least one mounting structure for detachably mounting the sample tube holder to a conveyor device of the laboratory sample transport system. In particular, the at least one mounting structure comprises a radial through-hole for accepting a, in particular threaded, bolt. Therein, the mounting structure is accessible for mounting of the sample tube holder at the conveyor device, in particular only, if at least one of the finger portions is elastically deflected radially outwardly. In other words: If none of the finger portions is elastically deflected radially outwardly, the mounting structure may at least partially be covered by at least one of the finger portions, so that the mounting structure is not accessible for mounting.

A mounting aid device according to the invention is adapted for mounting of a sample tube holder according to an, in particular the directly afore-mentioned, embodiment of the invention at the conveyor device of the laboratory sample transport system. Therein, the mounting aid device comprises a body extending along an axial direction of the mounting aid device and being axially acceptable by the central opening of the sample tube holder. Therein, the body is adapted to axially penetrate the central opening as to elastically deflect the finger portions radially outwardly. The body may therein function as a sample tube-dummy. The body has a radially recessed section, in particular a radial through-opening, for access of the mounting structure of the sample tube holder, in particular so that the mounting structure is accessible by a tool for mounting of the sample tube holder at the conveyor device through the radial recess section. If the body axially penetrated the central opening, the axial directions of both the sample tube holder and the mounting aid device may be congruent.

According to an embodiment of the invention, the body has at least one axial groove, the axial groove being adapted to accept one of the elastically radially outwardly deflected finger portions, so that the body axially penetrating the central opening is non-rotationally guided relative to the sample tube holder along the axial direction. This may allow for particularly reliable orientation of the radial recessed section of the body relative to the mounting structure of the sample tube holder to be mounted.

In particular, the mounting aid device may be used for mounting the sample tube holder at the conveyor device of the laboratory sample transport system and/or for demounting the sample tube holder from the conveyor device of the laboratory sample transport system.

A laboratory sample tube transport system according to the invention is adapted for transporting sample tubes. In particular, the laboratory sample tube transport system is adapted for use in a laboratory automation system. The laboratory automation system may provide for partial or full automation of a laboratory. The laboratory sample transport system comprises a conveyor device at which several sample tube holders according to the invention as described above are detachably mounted. Thus, the afore-mentioned advantages of the sample tube holder according to the invention may transfer to the laboratory sample tube transport system according to the invention having several of such sample tube holders.

The laboratory sample tube transport system may comprise a handling device, the handling device being adapted to load and/or unload the sample tube holders with sample tubes. For instance, the handling device may comprise a gripping device which is adapted to releasably grip a respective sample tube.

In addition, or as an alternative, the sample tube holder may be adapted for use in a rack for holding sample tubes. The rack the sample tube holder can be used in may be based on a rack as disclosed in WO 2010/054799 A1 and/or in EP3070479A1.

In addition, or as an alternative, the sample tube holder may be adapted for use in single holder for holding a single sample tube. The single holder the sample tube holder can be used in may be based on a single holder as disclosed in WO 2016/012555 A1 and/or in WO 2016/012517 A1 and/or in WO 2016/180648A2.

Further advantages and features of the invention arise from the claims as well as from the following description of a preferred embodiments of the invention, which are depicted by the drawings. Therein, equal reference signs relate to equal or similar or functionally equal components.

It is to be understood that the features mentioned above as well as the features described below are not only usable in the stated combination, respectively, but also in other combinations or solely, without leaving the scope of the present invention.

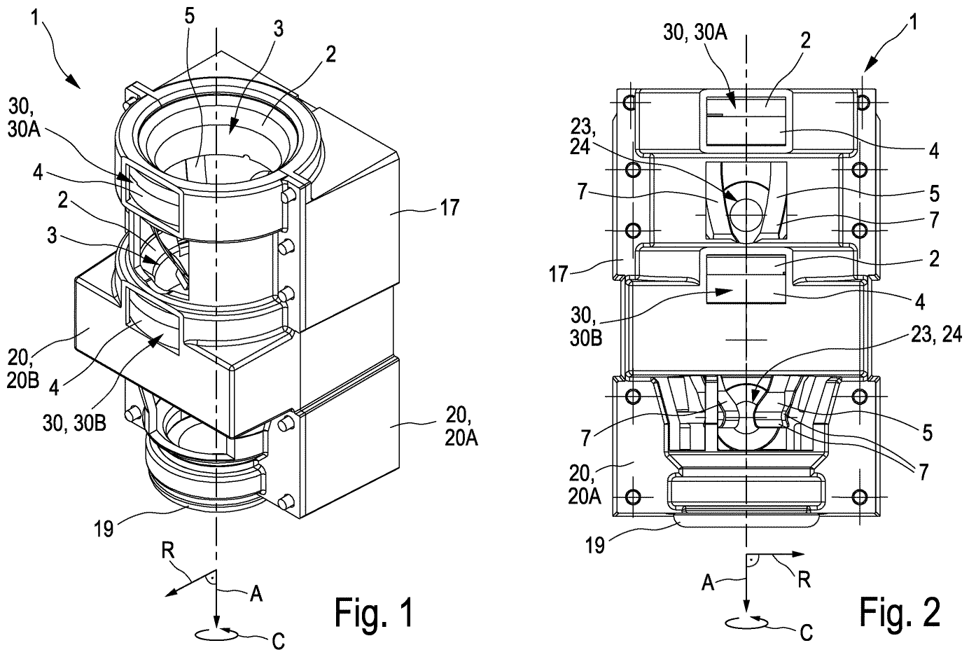

FIG. 1 schematically depicts, in a perspective view, a sample tube holder according to an embodiment of the invention,

FIG. 2 schematically depicts, in a front view, the sample tube holder of FIG. 1,

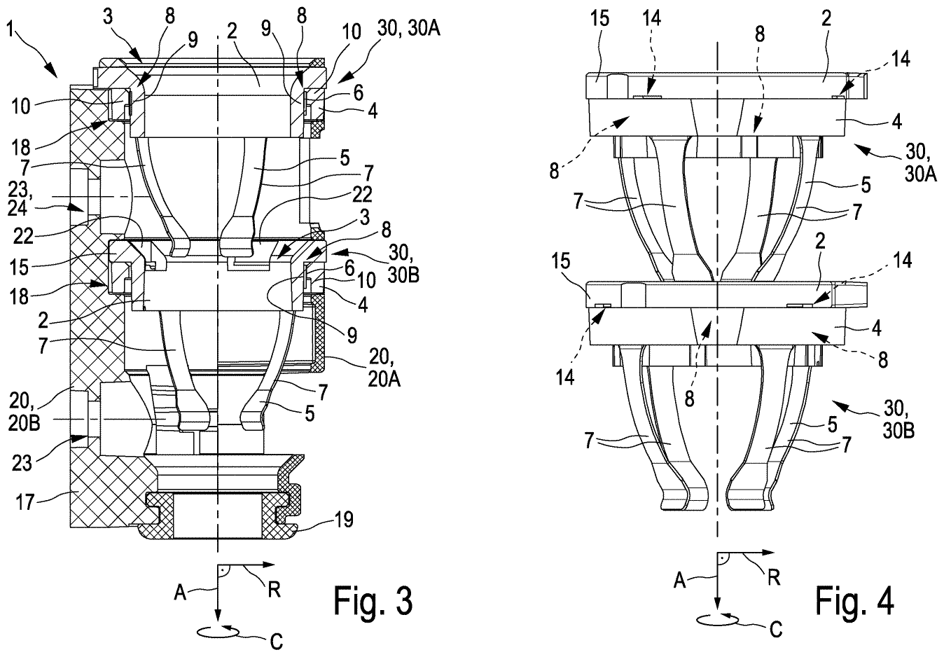

FIG. 3 schematically depicts, in a cross-section along an axial direction, the sample tube holder of FIGS. 1 and 2,

FIG. 4 schematically depicts, in a front view that corresponds to that of FIG. 2, the sample tube holder of FIGS. 1 to 3 with a housing of the sample tube holder being hidden,

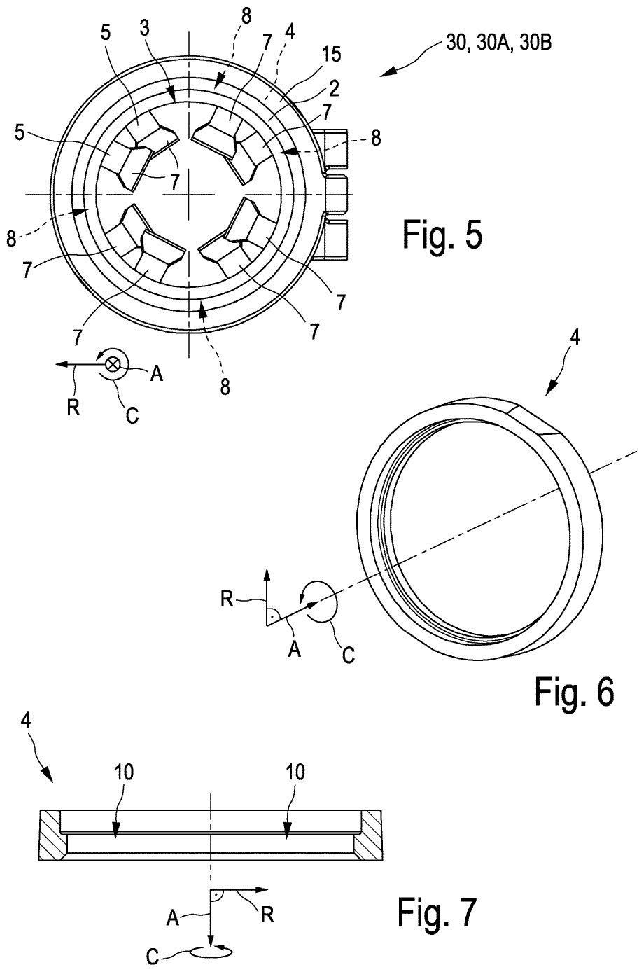

FIG. 5 schematically depicts, in a top view, the sample tube holder according to FIGS. 1 to 4 with the housing being hidden,

FIG. 6 schematically depicts, in a perspective view, a radial outer support member of the sample tube holder of FIGS. 1 to 5,

FIG. 7 schematically depicts, in a cross-section along the axial direction, the radial outer support member of FIG. 6,

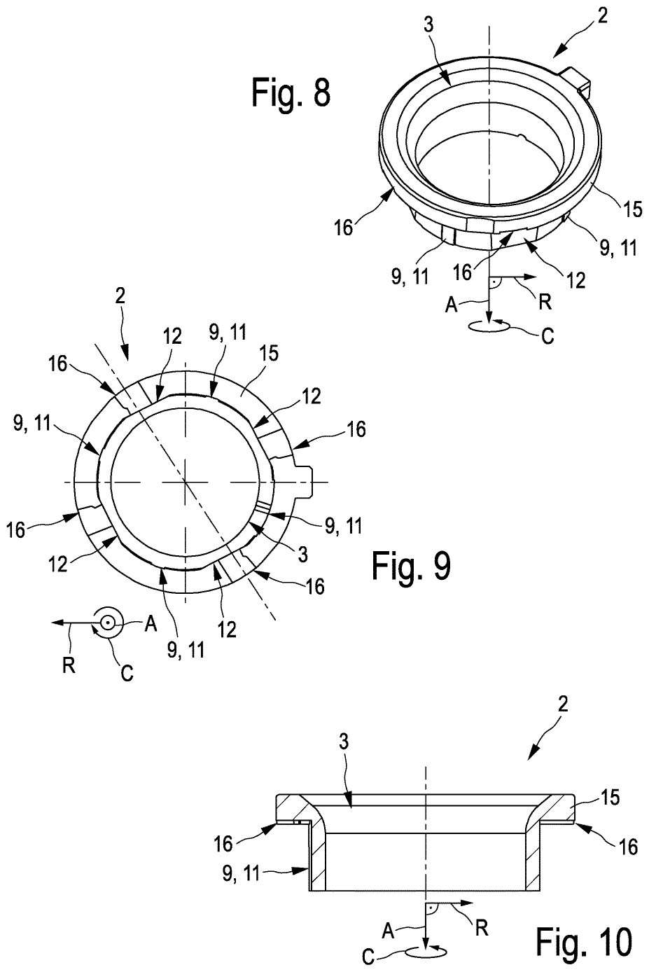

FIG. 8 schematically depicts, in a perspective view, a radial inner support member of the sample tube holder of FIGS. 1 to 5,

FIG. 9 schematically depicts, in a bottom view, the radial inner support member of FIG. 8,

FIG. 10 schematically depicts, in a cross-section along the axial direction, the radial inner support member of FIGS. 8 and 9,

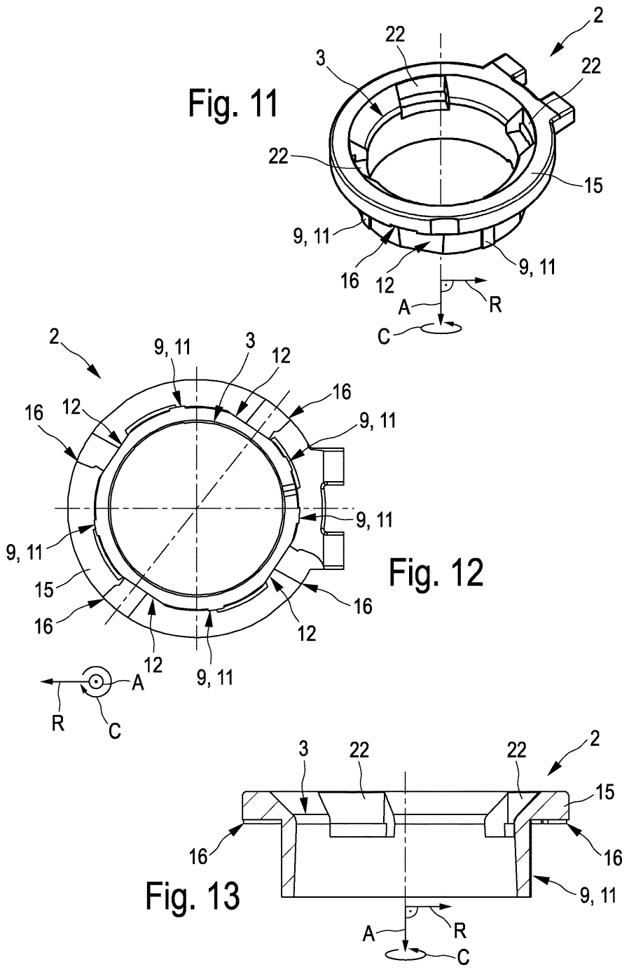

FIG. 11 schematically depicts, in a perspective view, another radial inner support member of the sample tube holder of FIGS. 1 to 5,

FIG. 12 schematically depicts, in a bottom view, the radial inner support member of FIG. 11,

FIG. 13 schematically depicts, in a cross-section along the axial direction, the radial inner support member of FIGS. 11 and 12,

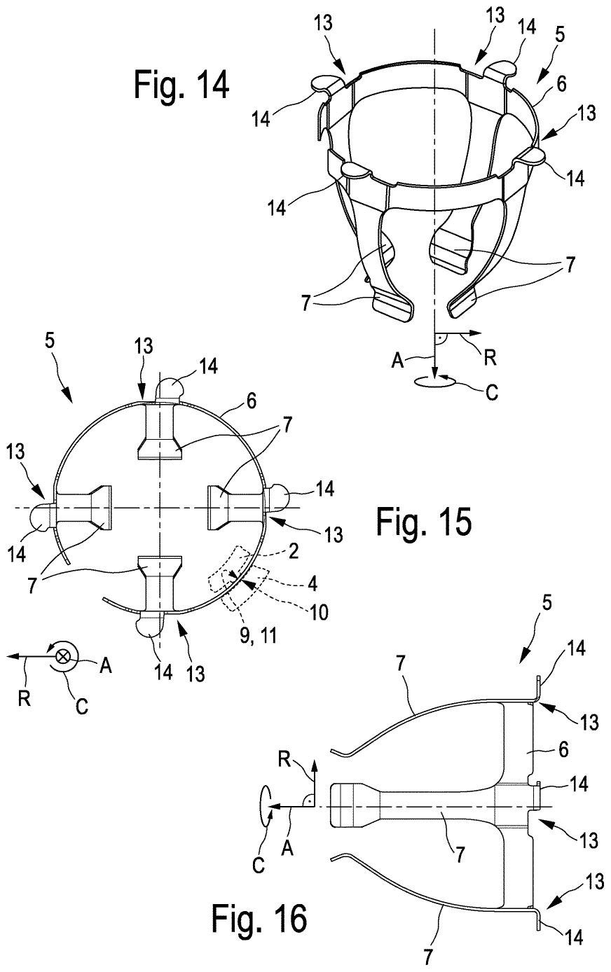

FIG. 14 schematically depicts, in a perspective view, a spring element of the sample tube holder of FIGS. 1 to 5,

FIG. 15 schematically depicts, in a top view, the spring element of FIG. 14,

FIG. 16 schematically depicts, in a cross-section along the axial direction, the spring element of FIGS. 14 and 15,

FIG. 17 schematically depicts, in a perspective view, a housing part of the sample tube holder of FIGS. 1 to 5,

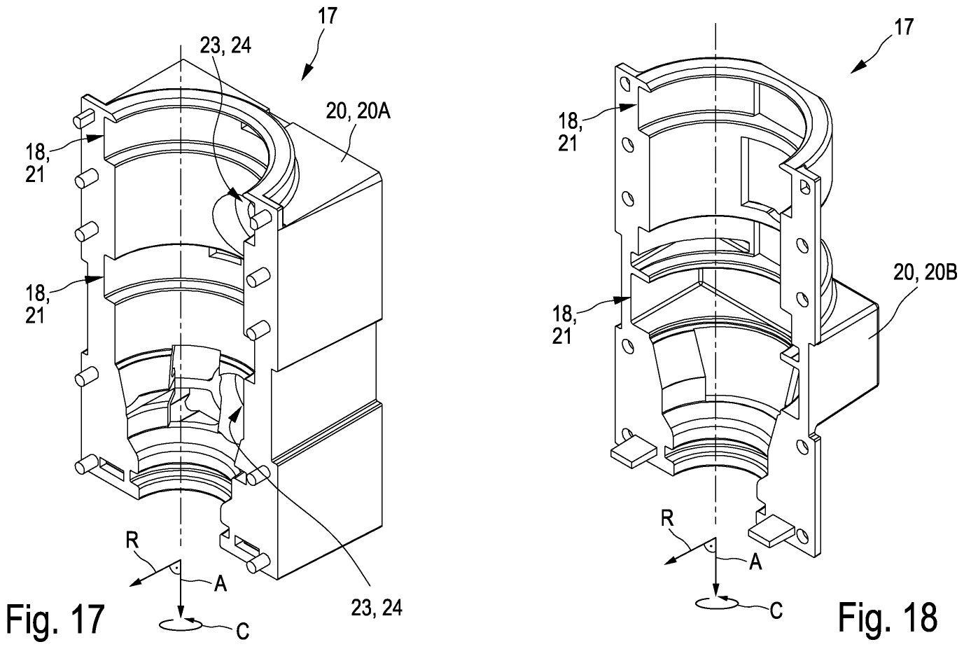

FIG. 18 schematically depicts, in a perspective view, another housing part of the sample tube holder of FIGS. 1 to 5,

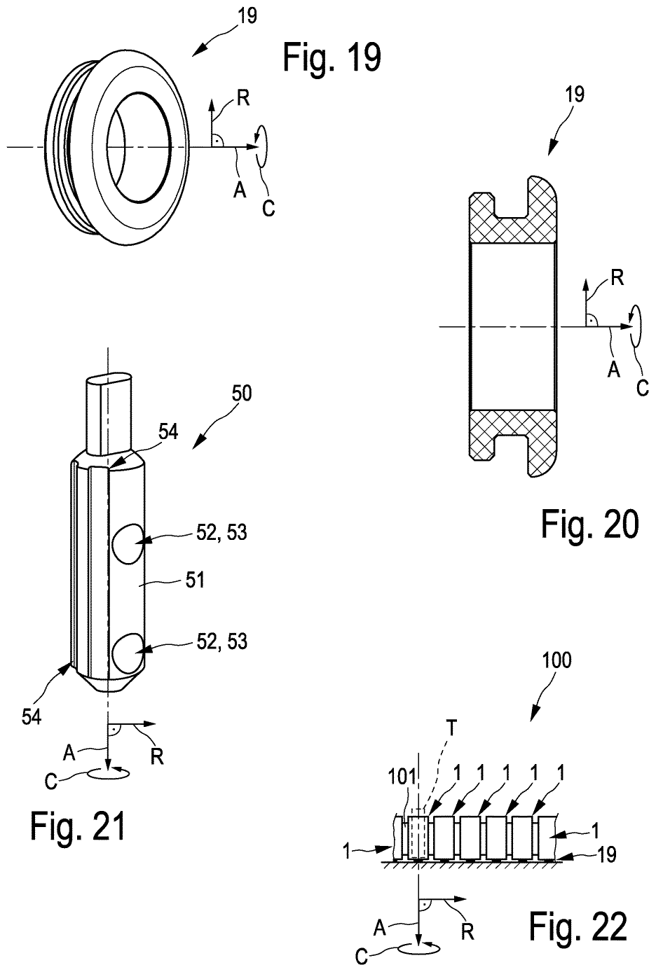

FIG. 19 schematically depicts, in a perspective view, a gliding member of the sample tube holder of FIGS. 1 to 5,

FIG. 20 schematically depicts, in a cross-section along the axial direction, the gliding member of FIG. 19,

FIG. 21 schematically depicts, in a perspective view, a mounting aid device according to an embodiment of the invention, and

FIG. 22 schematically depicts, in a front view, a laboratory sample tube transport system according to an embodiment of the invention.

A laboratory sample tube transport system 100 is adapted to transport sample tubes T. The laboratory sample tube transport system 100 may be comprised by and/or used within a laboratory automation system. The laboratory sample tube transport system 100 comprises a conveyor device 101. At the conveyor device 101, several sample tube holders 1 are detachably mounted. The conveyor device 101 may comprise a conveyor belt. The laboratory sample tube transport system 100 may comprise a handling device. The handling device may be adapted to load and/or unload the sample tube holders 1 with sample tubes T.

A respective one of the sample tube holders 1 comprises a radial inner support member 2. The radial inner support member 2 has a central opening 3. The central opening 3 is adapted to axially accept a respective sample tube T. The sample tube holder 1 comprises a radial outer support member 4. The radial outer support member 4 coaxially and/or radially nests the radial inner support member 2.

The sample tube holder 1 comprises a spring element 5. Therein, the spring element 5 has a base portion 6. The base portion 6 extends at least partially or—as best to be seen from FIGS. 14 and 15—only partially along a circumferential direction C of the sample tube holder 1. The base portion 6 is coaxially nested in between the radial inner support member 2 and the radial outer support member 4. The spring element 5 comprises a number of finger portions 7, for instance four finger portions 7. The finger portions 7 integrally protrude from the base portion 6. Therein, each of the finger portions 7 is curved radially inwardly. The finger portions 7 are adapted to be elastically deflected radially outwardly by a sample tube T axially penetrating the central opening 3.

A radial direction R of the sample tube holder 1 may be oriented perpendicular to an axial direction A of the sample tube holder 1. The radial direction R may be perpendicular to the circumferential direction C. The circumferential direction C may run within a radial plane, the radial plane being oriented perpendicular to the axial direction A.

The sample tube holder 1 comprises a number of clamping pairs 8. The clamping pairs 8 are adapted to clamp the base portion 6 in between the radial inner support member 2 and the radial outer support member 4. Therein, the clamping pairs 8 are distributed along the circumferential direction C, e.g. equidistantly. Each of the clamping pairs 8 comprises a first clamping portion 9 and a second clamping portion 10. Therein, the first clamping portion 9 is adapted to clamp-abut the base portion 6. The second clamping portion 10 is adapted to clamp-abut the base portion 6 directly opposite the first clamping portion 9 of the respective clamping pair 8. In particular, the first clamping portion 9 and the second clamping portion 10 are adapted to radially sandwich the base portion 6. Therein, the radial inner support member 2 comprises the first clamping portions 9 and the radial outer support member 4 comprises the second clamping portions 10.

As exemplary indicated in the drawing of FIG. 15, the base portion 6 is only locally clamped in between the radial inner support member 2 and the radial outer support member 4 at the clamping pairs 8. The base portion 6 may be only locally clamped radially at the clamping pairs 8.

For example, the base portion 6 is clamped radially between the radial inner support member 2 and the radial outer support member 4 at the clamping pairs 8, so that the spring element 5 stays in its axial position relative to the radial inner support member 2 and relative to the radial outer support member 4, in particular only, due to friction caused by the radial clamping. Therein, an axial gap may be present in between the base portion 6 and the radial inner support member 2 and/or in between the base portion 6 and the radial outer support member 4. This gap may define an axial play of the spring element 5 relative to the radial inner support member 2 and relative to the radial outer support member 4. The axial play may allow for a slight axial movement of the spring element 5 relative to the support members 2, 4 against the clamping friction, which may aid counteracting stress peaks in the spring element 5 upon elastic deflection of the finger portions 7.

For example, the radial inner support member 2 comprises radial protrusions 11. The radial protrusions 11 are distributed along the circumferential direction C, in particular equidistantly. Therein, the radial protrusions 11 of the radial inner support member 2 respectively comprise one of the first clamping portions 9. In addition, or as an alternative, the radial outer support member 4 may comprise radial protrusions 11 distributed along the circumferential direction C, wherein the radial protrusions 11 of the radial outer support member 4 respectively comprise one of the second clamping portions 10.

For example, the inner outer support member 2 comprises radial recesses 12. The radial recesses 12 of the radial inner support member 2 and the first clamping portions 9 are arranged alternatingly along the circumferential direction C. In addition, or as an alternative, the radial outer support member 4 may comprise radial recesses 12, wherein the radial recesses 12 of the radial outer support member 4 and the second clamping portions 10 are arranged alternatingly along the circumferential direction C.

As to be seen from the embodiment shown in the figures, it can be sufficient, if either the radial inner support member 2 or the radial outer support member 4 has radial protrusions 11 and/or radial recesses 12. In this case, the respective counterpart 2 or 4 may have a steady, in particular circumferential, surface, said surface comprising the clamping portions 9 or 10 of said counterpart 2 or 4, in particular without the clamping portions 9 or 10 of said counterpart 2 or 4 being, in particular radially, offset relative to said surface. As to be seen from FIGS. 6 and 7, the radial outer support member 4 may neither have radial recesses 12 nor radial protrusions 11, but the steady circumferential surface. As to be seen from FIGS. 8 to 13, for example only the radial inner support member 2 may comprise radial recesses 12 and radial protrusions 11.

For example, at least one of the radial recesses 12 may have a, in particular substantially, planar surface portion, said planar surface portion being perpendicular to the radial direction R. The planar surface portion may be oriented tangentially to the circumferential direction C. For example, all of the radial recesses 12 may have such a planar surface portion.

For instance, the base portion 6 comprises a number of torsion portions 13. The torsion portions 13 may be distributed along the circumferential direction C. Therein, the base portion 6 is not clamped in between the radial inner support member 2 and the radial outer support member 4 at the torsion portions 13, for example radially. The finger portions 7 may protrude from a respective one of the torsion portions 13.

As best to be seen from FIGS. 14 to 16, the base portion 6 may have flat portions. Therein, these flat portions extend substantially planarly perpendicular to the radial direction R and/or tangentially to the circumferential direction C. The finger portions 7 may integrally protrude from a respective one of the flat portions. The flat portions may be arranged at a transition between the finger portions 7 and the base portion 6.

For example, the spring element 5 comprises a number of radial projections 14. The radial projections 14 protrude integrally from the base portion 6, in particular opposite a respective one of the finger portions 7 along the axial direction A. The radial projections 14 may protrude from the torsion portions 13 of the base portion 6. The torsion portions 13 may be arranged in between the finger portions 7 and the radial projections 14 along the axial direction A.

For example, the radial inner support member 2 and/or the radial outer support member 4 have a flange portion 15. The flange portion 15 is adapted for mutual axial abutment of the radial inner support member 2 and the radial outer support member 4. Therein, the radial inner support member 2 and/or the radial outer support member 4 have recessed pockets 16. The recessed pockets 16 are partially delimited by the flange portion 15, in particular axially. Therein, the radial projections 14 are axially and/or radially movable accepted by the recessed pockets 16, respectively.

For example, the radial inner support member 2 and the radial outer support member 4 and the spring element 5 are comprised by a spring module 30, 30A, 30B of the sample tube holder 1. For instance, the sample tube holder 1 has at least two-according to the embodiment of the figures exactly two-spring modules 30, 30A, 30B. Therein, the spring modules 30, 30A, 30B are coaxially arranged at an axial distance relative to one another.

The spring modules 30, 30A, 30B may be pre-assembled at least partially from substantially similar or equal components. For example, the spring modules 30, 30A, 30B have an equal spring element 5. The spring modules 30, 30A, 30B may have an equal radial outer support member 4. For example, the spring modules 30, 30A, 30B may have a similar but not equal radial inner support member 2.

The sample tube holder 1 may comprise a housing 17. The housing 17 is adapted to carry the spring module 30, 30A, 30B. Therein, the housing 17 has an inner circumferential contour 18. The inner circumferential contour 18 is adapted to form-fittingly accept the radial outer support member 4 of the spring module 30, 30A, 30B. According to the embodiment shown in the figures, the housing 17 comprises two housing parts 20, 20a, 20b.

The housing parts 20, 20a, 20b are attached to one another perpendicular to the axial direction A of the sample tube holder 1. Therein, the housing parts 20, 20a, 20b respectively have a semi-circumferential contour segment 21 of the inner circumferential contour 18. The inner circumferential contour 18 is completed by, e.g. permanently, attaching the housing parts 20, 20a, 20b to one another.

The sample tube holder 1 may comprise a gliding member 19. The gliding member 19 may be ring-shaped. The gliding member 19 may be carried by the housing 17. The gliding member 19 may be arranged coaxially with respect to the spring module 30, 30A, 30B.

For example, the axial distance between the spring modules 30, 30A, 30B is less than a respective axial extension of the spring modules 30, 30A, 30B. Thus, the spring modules 30, 30A, 30B may partially axially overlap one another. In addition, or as an alternative, the spring modules 30, 30A, 30B are angularly shifted relative to one another around the circumferential direction C, for example by 25 ° to 35 °, as best to be seen from FIGS. 4 and 5.

According to the figures, the radial inner support member 2 of the spring module 30B has radial notches 22 which are adapted and arranged to radially accept the finger portions 7 of the other spring module 30A if said finger portions 7 are elastically deflected radially outwardly. Thus, the finger portions 7 of the other spring module 30A can be elastically deflected radially outwardly beyond an inner diameter of the central opening 3 of the radial inner support member 2 having the radial notches 22.

As best to be seen from FIGS. 2, 3 and 17, the sample tube holder 1 may comprise at least one mounting structure 23. The mounting structure 23 is adapted for detachably mounting the sample tube holder 1 to the conveyor device 101 of the laboratory sample transport system 100. Therein, the mounting structure 23 may comprise a radial through-hole 24. The radial through-hole 24 may be adapted to accept a, in particular threaded, bolt. The mounting structure 23 is accessible for mounting of the sample tube holder 1 at the conveyor device 101 if at least one of the finger portions 7 is elastically deflected radially outwardly. For example, the mounting structure 23 can only be accessed for mounting if at least one of the finger portions 7 is elastically deflected radially outwardly.

The sample tube holder 1 can be mounted at the conveyor device 101 by use of a mounting aid device 50. The mounting aid device 50 comprises a body 51. The body 51 extends, in particular substantially cylindrically, along an axial direction A of the mounting aid device 50. The body 51 is axially acceptable by the central opening 3 of the sample tube holder 1. If the body 51 is axially accepted by the central opening 3, the axial direction A of the mounting aid device 50 may match the axial direction A of the sample tube holder 1. The body 51 may have an axial lead-in chamfer. The body 51 is adapted to axially penetrate the central opening 3 as to elastically deflect the finger portions 7 radially outwardly. Therein, the body 51 has a radially recessed section 52 for access of the mounting structure 23 of the sample tube holder 1. The recessed section 52 may comprise a radial through-opening 53. For example, the radial recessed section 52 is adapted for access of the mounting structure 23 so that the mounting structure 23 is accessible by a tool for the mounting of the sample tube holder 1 at the conveyor device 101 through the radial recessed section 52.

The body 51 may have at least one axial groove 54. According to FIG. 21, the body 51 has a number of axial grooves 54 that matches a number of finger portions 7 of the sample tube holder 1. The at least one axial groove 54 may be adapted to accept a respective one of the elastically radially outwardly deflected finger portions 7 if the body 51 penetrates the central opening 3. The body 51 axially penetrating the central opening 3 may be non-rotationally guided relative to the sample tube holder 1 along the axial direction A.

The laboratory sample tube transport system 100 may comprise a handling device, the handling device being adapted to load and/or unload the sample tube holders 1 with sample tubes T.

1. A sample tube holder for a laboratory sample tube transport system, the sample tube holder comprising:
a radial inner support member having a central opening for axially accepting a sample tube;
a radial outer support member coaxially nesting the radial inner support member;
a spring element, the spring element comprising:
a base portion at least or only partially extending along a circumferential
direction of the sample tube holder, the base portion being coaxially nested in between the radial inner support member and the radial outer support member, and
a number of finger portions integrally protruding from the base portion, the finger portions being curved radially inwardly, the finger portions being adapted to be elastically deflected radially outwardly by a sample tube axially penetrating the central opening; and
a number of clamping pairs for clamping the base portion in between the radial inner support member and the radial outer support member, the clamping pairs being distributed along the circumferential direction;
the clamping pairs respectively comprising a first clamping portion for clamp-abutting the base portion and a second clamping portion for clamp-abutting the base portion directly opposite said first clamping portion.
the radial inner support member comprising the first clamping portions and the radial outer support member comprising the second clamping portions.

2. The sample tube holder according to claim 1, wherein
the radial inner support member comprises radial protrusions distributed along the circumferential direction, the radial protrusions of the radial inner support member respectively comprising one of the first clamping portions, and/or
the radial outer support member comprises radial protrusions distributed along the circumferential direction, the radial protrusions of the radial outer support member respectively comprising one of the second clamping portions.

3. The sample tube holder according to claim 1, wherein
the radial inner support member comprises radial recesses, the radial recesses of the radial inner support member and the first clamping portions being alternatingly arranged along the circumferential direction, and/or
the radial outer support member comprises radial recesses, the radial recesses of the radial outer support member and the second clamping portions being alternatingly arranged along the circumferential direction.

4. The sample tube holder according to claim 1, wherein
the base portion is only locally clamped in between the radial inner support member and the radial outer support member at the clamping pairs, in particular radially.

5. The sample tube holder according to claim 1, wherein
the base portion is clamped radially between the radial inner support member and the radial outer support member at the clamping pairs, so that axially the spring element is frictionally connected to the radial inner support member and the radial outer support member,
in particular an axial gap defining an axial play of the spring element relative to the radial inner support member and relative to the radial outer support member being present in between the base portion and the radial inner support member and/or in between the base portion and the radial outer support member.

6. The sample tube holder according to claim 1, wherein
the base portion comprises a number of torsion portions distributed along the circumferential direction,
the base portion not being clamped in between the radial inner support member and the radial outer support member at the torsion portions, in particular radially,
in particular at least one of the finger portions protruding from a respective one of the torsion portions.

7. The sample tube holder according to claim 1, wherein
the spring element comprises:
a number of radial projections integrally protruding from the base portion in particular from torsion portions of the base portion
the radial inner support member and/or the radial outer support member having a flange portion for mutual axial abutment of the radial inner support member and the radial outer support member,
the radial inner support member and/or the radial outer support member having recessed pockets partially delimited by the flange portion, in particular axially,
the radial projections being axially and/or radially movably accepted by the recessed pockets, respectively.

8. The sample tube holder according to claim 1, wherein
the radial inner support member and the radial outer support member and the spring element are comprised by a spring module of the sample tube holder.

9. The sample tube holder according to claim 8, wherein
the sample tube holder comprises a housing for carrying the spring module,
the housing having an inner circumferential contour for form-fittingly accepting the radial inner support member and/or the radial outer support member of the spring module,
in particular the sample tube holder comprising a, in particular ring-shaped, gliding member carried by the housing, in particular the gliding member being arranged coaxially with respect to the spring module.

10. The sample tube holder according to claim 9, wherein
the housing comprises two housing parts which are attached to one another perpendicular to an axial direction of the sample tube holder.
the housing parts respectively having a semi-circumferential contour segment of the inner circumferential contour, the inner circumferential contour being completed by, in particular permanently, attaching the housing parts to one another.

11. The sample tube holder according to claim 8, wherein
the sample tube holder has at least two, in particular exactly two, spring modules coaxially arranged at an axial distance relative to one another, in particular the spring modules being pre-assembled at least partially from substantially similar or equal components.

12. The sample tube holder according to claim 11, wherein
the axial distance is less than a respective axial extension of the spring modules so that the spring modules partially axially overlap, and/or in that
the spring modules are angularly shifted relative to one another around the circumferential direction, in particular by 25 degrees to 35 degrees.

13. The sample tube holder according to claim 1, wherein
the sample tube holder comprises at least one mounting structure, in particular comprising a radial through-hole for accepting a, in particular threaded, bolt, for detachably mounting the sample tube holder to a conveyor device of the laboratory sample transport system,
the mounting structure being accessible for mounting of the sample tube holder at the conveyor device, in particular only, if at least one of the finger portions is elastically deflected radially outwardly.

14. A mounting aid device for mounting of a sample tube holder according to claim 13 at the conveyor device of the laboratory sample transport system, the mounting aid device comprising:
a body extending along an axial direction of the mounting aid device and being axially acceptable by the central opening,
the body being adapted to axially penetrate the central opening as to elastically deflect the finger portions radially outwardly,
the body having a radially recessed section in particular a radial through-opening for access of the mounting structure in particular so that the mounting structure is accessible by a tool for mounting of the sample tube holder at the conveyor device through the radially recessed section.

15. The mounting aid device according to claim 14, wherein
the body has at least one axial groove the axial groove being adapted to accept one of the elastically radially outwardly deflected finger portions, so that the body axially penetrating the central opening is non-rotationally guided relative to the sample tube holder along the axial direction

16. A laboratory sample tube transport system for transporting sample tubes, the laboratory sample tube transport system comprising:
a conveyor device at which several sample tube holders according to claim 1 are detachably mounted.
